(19) United States
(12) Patent Application Publication
(10) Pub. No.: US 2026/0365580 A1
(43) Pub. Date: Nov. 19, 2026

(54) SETTING-TYPE COMPOUND WITH ENHANCED PROPERTIES

(71) Applicant: United States Gypsum Company, Chicago, IL (US)

(72) Inventors: Phanindra KODALI, Mundelein, IL (US); Renee Jane WEINBERGER, Waukegan, IL (US); Rafael BURY, Wheeling, IL (US); Jelena DINIC, Darien, IL (US)

(21) Appl. No.: 19/380,258

(22) Filed: Nov. 5, 2025

Related U.S. Application Data
(60) Provisional application No. 63/805,707, filed on May 14, 2025.

(51) Int. Cl. C04B 28/14; C04B 14/10; C04B 14/18; C04B 14/22; C04B 14/28; C04B 22/06; C04B 24/38; C04B 103/40; C04B 103/44; C04B 111/00; C04B 111/40

(52) U.S. Cl. CPC C04B 28/14; C04B 14/102; C04B 14/185; C04B 14/22; C04B 14/28; C04B 22/066; C04B 24/383; C04B 2103/408; C04B 2103/44; C04B 2111/00508; C04B 2111/40

(57) ABSTRACT

A lightweight and easy-to-sand setting-type joint compound composition with enhanced bonding to a non-porous surface, including to a wallboard paper facer, the setting-type joint compound comprising a lightweight filler and a polymeric binder, and methods for finishing wallboard installation, flat seams, corner seams and repairing wallboard by mixing the setting-type joint compound composition with water into a paste and applying the paste over seams and/or wallboard surface.

### CROSS-REFERENCE TO RELATED APPLICATIONS

This application claims the benefit of priority from U.S. provisional patent application 63/805,707 filed May 14, 2025, the entire disclosure of which is herein incorporated by reference in its entirety.

### TECHNICAL FIELD

This disclosure relates to setting-type joint compounds which are lightweight, easy to sand and bond well to a non-porous surface, including to wallboard having a coated paper facer, and methods for finishing flat seams, corner seams, and repairing wallboard, including wallboard faced with a facer paper coated with a pigment coating and/or having a porosity lower than that of manila paper.

### BACKGROUND

A wallboard panel, also known as gypsum board or drywall, is a commonly used for constructing interior walls and ceiling, for example as described in U.S. Pat. No. 9,249,578. When building an interior wall, wallboard panels may be fastened, side-by-side, to framing members, e.g. wood studs or metal framing, with fasteners, screws or nails. In order to produce a monolithic and uniform wall surface, seams (joints) between adjacent wallboard panels, fasteners and any imperfections on affixed wallboard panel surfaces must be further prepared by using a joint compound. In this multi-step preparation process, a joint compound is applied to fill seams and joint tape is embedded into the joint compound. A second coat of joint compound is then applied over the seam as well as over an adjacent portion of about 2 inches of the wallboard surface. Finally, a third coat of joint compound is applied over the second coat. The third coat of the joint compound may extend even further over the wallboard surface than the second coat. After each of the second and third coats hardens, it is typically sanded. It is desirable that a joint compound used for the second and third coatings are easy to sand and fast-drying and that the finishing joint compound adheres well to wallboard facer paper.

Traditionally, wallboard facer paper is made as multi-ply paper, known as manila paper, composed of several plies of filler stock made from Kraft clippings and waste news, and two plies faced outwardly made from flyleaf shavings stock, for example as described in U.S. Pat. No. 4,853,085. However, the availability of recycled newsprint and flyleaf shaving fibers has diminished significantly in recent years, resulting in development of modified facer paper produced without flyleaf shavings. This modified facer paper is often coated with a coating comprising a pigment dispersed in polymeric binder for offsetting a dark color of the modified paper and minimizing dark color bleeding through after a paint coating is applied. The modified facer paper may be much less porous than traditional manila paper. Therefore, there is a need in the field for joint compounds that bond efficiently to facer paper, including to coated paper and/or to modified paper having a porosity lower than that of manila paper.

### SUMMARY

These and other needs are addressed at least partially with a setting-type joint compound according to this disclosure, the setting-type joint compound being lightweight, fast-drying and having a significantly stronger bonding to wallboard facer paper coated with a polymeric coating and/or having a porosity lower than that of manila paper.

In one aspect, this disclosure relates to a setting-type joint compound composition in powder form, comprising:
calcium sulfate hemihydrate;
calcium carbonate;
a lightweight filler comprising silicone-coated expanded perlite microspheres, hollow glass microspheres, and/or expanded polymeric hollow microspheres filled with gas and surface-coated with calcium carbonate;
a binder comprising a vinyl acetate co-polymer;
a thickener comprising clay, starch, a cellulosic thickener, or any combination thereof;
a dispersant;
magnesium oxide or magnesium hydroxide; and
a set initiator comprising ground gypsum,
   wherein the setting-type joint compound composition is suitable for use over a wallboard coated paper facer, including over the wallboard coated paper facer which comprises a surface polymeric coating comprising a pigment.

In some preferred embodiments, the setting-type joint compound composition may consist essentially of:
40-60 wt % calcium sulfate hemihydrate;
35-50 wt % calcium carbonate;
1-9 wt % of the lightweight filler;
1.5-5 wt % of the binder;
0.1-1 wt % of the cellulosic thickener;
1.0-10 wt % of attapulgite clay;
0.5-5 wt % of starch;
0.01-1.2 wt % magnesium oxide or magnesium hydroxide;
0.02-1.0 wt % dispersant;
0.01-0.1 wt % of the set initiator; and
0.00-0.1 wt % of keratin-based setting-reaction controlling agent.

Preferably, the binder may comprise a vinyl acetate-ethylene co-polymer and more preferably, the binder may further comprise polyvinyl alcohol which in some embodiments can be used an amount ranging from about 0.05 wt % to about 0.5 wt %.

In some embodiments, the setting-type joint compound composition may comprise pregelatinized corn and/or wheat starch. It has been found that the setting-type joint compound composition according to this disclosure may have at least 80% bond to wallboard facer paper having a porosity ranging 35-500 seconds/100 cm³, or more preferably at least 90% to wallboard facer paper having a porosity ranging 150-500 seconds/100 cm³. Preferably, the set initiator comprises ground gypsum coated with sugar. In some embodiments of the setting-type joint compound composition, the binder may comprise a mixture of vinyl acetate-versatic ester co-polymer, ethylene vinyl acetate and vinyl alcohol co-polymer, vinyl alcohol polymer and vinyl acetate polymer.

In another aspect, this disclosure relates to a method of finishing or repairing wallboard having a facer paper sheet, the method comprising mixing the setting-type joint compound composition of this disclosure with water into a paste and applying the paste over at least a portion of the facer paper sheet surface. The method may further comprise sanding after the applied paste has hardened. The methods can be performed with the facer paper sheet which does not comprise flyleaf fibers. In embodiments, the facer paper sheet may have a porosity ranging from 100 to 500 seconds per 100 cm³, wherein the porosity is measured according to the ASTM C 474 paper bonding test.

In yet another aspect, this disclosure relates to a use of the setting-type joint compound composition of this disclosure for bonding a non-porous surface, including a wallboard paper facer sheet having a porosity of 100 seconds per 100 cm³ or lower, preferably the porosity ranging 100 to 500 seconds per 100 cm³.

### BRIEF DESCRIPTION OF THE DRAWINGS

FIG. 1 is a cross-sectional view of a wallboard faced with modified facer paper.

FIGS. 2A-2E depict preparing a test assembly for paper-bonding test. FIG. 2A depicts spreading a joint compound. FIG. 2B depicts applying facer paper over the joint compound. FIG. 2C depicts using a broad knife to place the facer paper in full contact with the joint compound. FIG. 2D depicts the test assembly with “X” marks cut on the facer paper surface. FIG. 2E depicts a transparent grid being placed over the test assembly surface for calculating percent bond.

FIG. 3A reports results of the paper bond test for a lightweight conventional joint compound. Sample 32 paper has a polymeric coating and/or having a porosity lower than that of manila paper.

FIG. 3B reports results of the sample 32 paper bond test for a joint compound according to this disclosure.

### DETAILED DESCRIPTION

In this disclosure, “wt %” means percentage by weight. In this disclosure, all percentages and ratios are by weight, unless specifically stated otherwise.

In this disclosure, “about” means a value plus/minus 10%. For example, “about 100” means 100±10 and “about 200” means 200=20.

In this disclosure, “room temperature” is referred to the following temperature: 75±5 °F (24±2 °C).

In this disclosure, “normal atmospheric pressure” refers to normal atmospheric pressure at sea level ranging between 950 and 1050 hectopascales (hPa).

In this disclosure, all tests are conducted at room temperature, approximately 50% relative humidity (RH), and normal atmospheric pressure, unless specifically stated otherwise. Relative humidity (RH) is a measure of the water vapor content of air, expressed as a percentage of the amount needed to achieve saturation at the same temperature. To measure relative humidity (RH) a hydrometer can be used.

In this disclosure, ASTM is the abbreviation which stands for the American Society for Testing and Materials, also known as ASTM International, a globally recognized organization that develops and publishes voluntary consensus standards.

In this disclosure, ASTM C 474 refers to the Standard Test Methods for Joint Treatment Materials, ASTM C 474, developed and published by ASTM International.

In this disclosure, the term “composition” may be used interchangeably with the term “mixture” or “formulation.” Compositions include dry powder formulations which do not comprise added water or liquid components, as well as compositions in liquid, slurry or paste form which comprise water and/or liquid components added.

In this disclosure, “a dry joint compound composition” means that the composition does not contain aqueous water or liquid components. Preferably, the composition may be in powder form. However, a dry composition or dry mixture may have some moisture content and may contain components with bound water molecules.

In this disclosure, “dry component” means a component which does not comprise aqueous water or liquid additives. The dry component may have some moisture content and may contain bound water molecules.

In this disclosure “by wt % on a dry basis of the composition” means by weight of dry components, not including aqueous water or liquid components.

In this disclosure, the term “gypsum” may refer to any of the following: naturally mined gypsum (ore), landplaster and/or synthetic gypsum. Gypsum may also include gypsum which originates from a waste stream, as a bi-product, or a recycled material, such as dry wall. The term “gypsum” may be used interchangeably with the term “calcium sulfate dihydrate” or CaSO₄·2H₂O. The term “synthetic gypsum” can be also referred to as “chemical gypsum,” or flue gas desulfurization (FGD) gypsum.

In this disclosure, the term “calcined gypsum” may be used interchangeably with calcium sulfate hemihydrate, stucco, calcium sulfate semi-hydrate, calcium sulfate half-hydrate, plaster of Paris, or CaSO₄·½H₂O.

When calcined gypsum (CaSO₄·½H₂O) is mixed with water into a slurry or paste, calcined gypsum reacts with water, hydrates and sets (hardens) into a gypsum matrix. This setting reaction can be defined by the following chemical equation (I):

CaSO₄·½H₂O+ 3/2H₂O→CaSO₄·2H₂O

In this disclosure, the term “limestone” may be used interchangeably with calcium carbonate or CaCO₃.

In one aspect, this disclosure relates to a setting-type joint compound, preferably in powder form, having acceptable bonding strength, preferably 80%, 85%, 90%, 95% or higher, to wallboard facer paper, including to wallboard facer paper having a porosity lower than that of manila facer paper. In addition to the enhanced bonding, the setting-type joint compound is lightweight, easy to sand and fast-setting, and fast-drying, and preferably ready to be sanded in two hours or less, and more preferably in one hour or less. In order to achieve these technical properties, the setting-type joint compound comprises several necessary components, including calcium sulfate hemihydrate, a filler, a lightweight filler, a particular binder, a dispersant, a set initiator and a setting-reaction controlling mixture.

A first necessary component in the setting-type joint compound composition according to this disclosure is calcium sulfate hemihydrate sourced as calcined gypsum which can be prepared by calcining gypsum, including as originally described in U.S. Pat. No. 1,931,240. The setting-type joint compound compositions according to this disclosure may comprise at least 40 wt % or more, such as preferably 40-60 wt %, more preferably 42-55 wt %, and most preferably 42-50 wt % of calcium sulfate hemihydrate.

A second necessary component in the setting-type joint compound according to this disclosure is calcium carbonate which can be sourced from ground limestone, dolomite, or any mixture thereof. Preferably, amounts of calcium carbonate can be at least 35 wt % or higher, preferably 40 wt %-50 wt % and most preferably 40 wt %-45 wt %.

A third necessary component in the setting-type joint compound according to this disclosure is a lightweight filler which may include one or more of the following: expended perlite microspheres, hollow glass microspheres which can be produced by following U.S. Pat. No. 9,00,630, and/or expanded polymeric hollow microspheres filled with gas and surface-coated with calcium carbonate which can be produced by following U.S. Pat. No. 4,397,799. The setting-type joint compound compositions may comprise from 1 to 9 wt %, preferably from 1.5 to 7 wt % of the lightweight filler.

Expanded perlite (a naturally occurring volcanic glass material) is caused to be lightweight and porous by a heat treatment. Optionally, expanded perlite is coated with a surface coating which improves water-resistance of expanded perlite, which can be produced by following U.S. Pat. No. 4,525,388. The surface coating may comprise waxes, polymers and/or silicates. In the joint compound compositions according to this disclosure, perlite may be silicone-coated expanded perlite microspheres.

In addition to, or instead of expanded perlite (coated or uncoated), the lightweight filler may comprise glass microspheres, preferably hollow glass microspheres, including hollow glass microspheres having a density of 0.125 g/cm³ and a crush strength of at least 250 psi or higher. Hollow glass microspheres may be made of soda-lime borosilicate glass. Preferably, hollow glass microspheres have a median particle size by volume of 20 micrometers or higher, e.g. 20, or 30, or ranging 20-65 micrometers.

In this disclosure, particle sizes may be measured with a particle size analyzer (a laser diffractometer) which uses light scattering to determine particle size, for example as described in U.S. Pat. No. 9,00,630. In this disclosure, the median particle size, also known as D50, is the particle size at which 50% of the sample by volume is smaller and 50% is larger. D50 by volume is measured with the particle size analyzer.

In addition to expanded perlite and/or hollow glass microspheres, or instead of expanded perlite and/or hollow glass microspheres, the setting-type joint compound compositions according to this disclosure may comprise expanded polymeric hollow microspheres filled with gas and surface-coated with calcium carbonate. Preferably, the expanded polymeric hollow microspheres may have a density of about 0.130 g/cm³ and a median particle size by volume (D50) in the range of 45-65 micrometers. It has been unexpectedly found that setting-type composition comprising hollow glass microspheres and/or expanded polymeric hollow microspheres filled with gas and surface-coated with calcium carbonate are easier to hand mix with water in comparison to compositions which comprise perlite.

A fourth necessary component in the setting-type joint compound compositions according to this disclosure is a binder which comprises a vinyl acetate co-polymer comprising vinyl acetate (C₄H₆O₂) repeating units (monomers). The vinyl acetate co-polymer binder may be sourced as redispersible latex powder. It has been unexpectedly found that a joint compound composition according to this disclosure has a stronger bonding to modified paper facer when the joint compound composition comprises a vinyl acetate copolymer comprising vinyl acetate monomers co-polymerized with one or more of the following groups: ethylene, vinyl ester, vinyl versatate, butyl acrylate, vinyl alcohol, or any combination thereof. In the vinyl acetate co-polymer, the weight percent of vinyl acetate may vary from 10 to 50 wt %, with the remainder being sourced from ethylene, vinyl ester, vinyl versatate, butyl acrylate, vinyl alcohol, or any combination thereof.

Preferably, the binder may comprise a vinyl acetate-ethylene copolymer composed of ethylene (C₂H₄) and vinyl acetate (C₄H₆O₂) repeating units linked into a polymer chain, and sourced as redispersible latex powder. In the vinyl acetate-ethylene copolymer, the weight percent of vinyl acetate may vary from 10 to 50 wt %, with the remainder being preferably ethylene.

In some embodiments, the binder may further include polyvinyl alcohol which may be further supplied in combination with vinyl acetate polymer (homopolymer).

In some preferred embodiments, the vinyl acetate co-polymer may be a mixture of several co-polymers and polymers. In most preferred embodiments, the vinyl acetate co-polymer mixture may comprise the following co-polymers and polymers: vinyl acetate-versatic ester co-polymer, ethylene vinyl acetate and vinyl alcohol co-polymer, polyvinyl alcohol polymer and vinyl acetate homopolymer.

The vinyl acetate co-polymer binder according to this disclosure may be used in any suitable amounts, and preferably in an amount of 1.5 wt % or higher, 2.0 wt % or higher. For example, the binder may be used in an amount from about 1.5 wt % to about 5.0 wt %. It has been unexpectedly found that a significantly improved percent bond to wallboard facer paper, including wallboard facer paper that does not comprise flyleaf fibers and/or has a porosity lower than that of facer manila paper can be achieved with the vinyl acetate co-polymer binders, and in particular with a binder comprising a vinyl acetate-ethylene copolymer.

A fifth necessary component in the setting-type joint compound compositions according to this disclosure is a dispersant composed naphthalene sulfonate or polycarboxylate ether, or sodium lignosulfonate. In embodiments, from about 0.02 to about 1.0 wt %, preferably from about 0.1 to about 1.0 wt % of a dispersant may be used.

The setting-type joint compounds according to this disclosure may further comprise thickeners, magnesium oxide or magnesium hydroxide, a set initiator, a setting-reaction controlling mixture, or any combination thereof. The pH of the setting-type joint compounds after they are mixed with water may be preferably in the range from about 7.5 to about 9.9.

Preferred thickeners may include a cellulosic thickener, clay, starch, or any combination thereof.

Suitable cellulosic thickeners may include a cellulosic ether in which hydroxyl groups on the cellulose molecule are replaced with ether groups which may include methyl, ethyl, propyl, and/or hydroxyethyl groups. Examples of suitable cellulosic thickeners include, but are not limited to, methyl cellulose (MC), ethyl cellulose (EC) hydroxyethyl cellulose (HEC) and hydroxypropyl methyl cellulose (HPMC) among many others. The cellulosic thickeners can be used in a small amount. For example, in any amount ranging from about 0.1 to about 1 wt %, preferably ranging 0.1 to 0.5 wt %.

Any of the following cellulosic thickeners can be used either alone, or in combination with other cellulosic thickeners and further in combination with clay and/or starch.

The setting-type joint compound compositions may include clay, and in particular attapulgite clay, sepiolite clay, bentonite clay, kaolin clay, and/or laponite. Preferably, the setting-type joint compound compositions may comprise attapulgite clay. If present, clay, preferably attapulgite clay, may be used in any suitable amount ranging from about 1.0 to about 10 wt %, preferably 1 to 5 wt %.

The setting-type joint compound composition may comprise one or more starches, preferably pregelatinized starches, which may include wheat starch, corn starch, or any combination thereof, but any other starch (potato, tapioca) can be also used. The setting-type joint compound compositions according to this disclosure may comprise from about 0.5 to about 5 wt %, preferably 0.5 to 1 wt % of starch, preferably pregelatinized starch, most preferably pregelatinized wheat starch.

Magnesium oxide or magnesium hydroxide can be used in any suitable amount for pH modification. In some embodiments, from about 0.01 to about 1.2 wt % of magnesium oxide or magnesium hydroxide can be used.

The setting-type joint compounds may further comprise a set initiator, which can be referred to as a set accelerator, comprising ground gypsum which may be sugar-coated for example with glucose, sucrose and/or dextrose, but any other sugar can be also used so long as the sugar can be caramelized when heated. The sugar-coating may be achieved by co-griding gypsum with sugar and then heating to about 250 °F or higher and caramelizing the sugar, allowing it to surface-coat gypsum particles as described in U.S. Pat. Nos. 3,573,947 and 6,379,458. The coated calcium sulfate dihydrate may serve as “seed crystals,” promoting crystal growth during the hydration reaction with the chemical equation (I) in the setting-type joint compound according to this disclosure. The set initiator can be used in small amounts, for example from about 0.01 to about 0.1 wt %, and preferably from 0.01 to 0.05 wt %.

In some embodiments, the setting-type joint compounds may further comprise one or more setting-reaction controlling agents used in order to increase open time during which the setting-type joint compound is workable and can be applied to a wallboard surface. The working time may be increased to 1 hour, 1.5 hour, 2 hours, or more. If present, these agents can be used in any suitable amount, for example from about 0.01 to about 0.1 wt %.

The setting-reaction controlling agent may comprise purified hydrolyzed keratin composition and calcium carbonate. The hydrolyzed keratin composition can be produced from animal hair and hooves. Other setting-reaction controlling agents may be used instead of or in addition to the hydrolyzed keratin composition. These agents may include, but are not limited to, citric acid, tartaric acid, crem of tartar (potassium bitartrate), and/or Rochelle salt (sodium potassium tartrate).

Preferably, the setting-type joint compounds according to this disclosure are formulated with dry components as powder. One embodiment of the setting-type joint compound according to this disclosure is listed in Table 1 below.

TABLE 1
Setting-Type Joint Compound with Enhanced Bond to Facer Paper

| Component | Range (wt %) | Preferred Range (wt %) |
|---|---|---|
| Calcium sulfate | 40-60 | 42-55 |
| hemihydrate | | |
| Calcium Carbonate | 35-50 | 40-45 |
| Lightweight Filler | 1-9 | 1.5-7 |
| A binder comprising | 1-5 | 1.5-2 |
| vinyl acetate co- | | |
| polymer | | |
| Cellulosic Thickener | 0.1-1 | 0.1-0.5 |
| Attapulgite Clay | 1.0-10 | 1-5 |
| Pregelatinized Starch | 0.5-5 | 0.5-1 |
| Magnesium | 0.01-1.2 | 0.01-1 |
| Oxide/Magnesium | | |
| Hydroxide | | |
| Napthalene Sulfonate | 0.01-0.1 | 0.02-0.06 |
| (dispersant) | | |
| Set Initiator (Coated | 0.01-0.1 | 0.01-0.05 |
| Ground Gypsum) | | |
| Keratin-Based Setting- | 0.00-0.1 | 0.02-0.05 |
| Reaction Controlling | | |
| Agent | | |

In order to use the setting-type joint compound which is preferably formulated in powder form, a user can mix the setting-type joint compound with water to obtain a paste-like formulation. Water can be used in any suitable amounts in order to obtain a paste-like formulation. Preferably, between 0.4 and 0.7 parts of water by volume can be used per one part by weight of the setting-type joint compound. For example, from 0.2 to 0.7 liters of water can be used per one kilogram of the setting-type joint compound according to this disclosure. In some embodiments, between 8.5 (4.02 liters) and 10 (4.73 liters) U.S. liquid pints of water can be added per 25 lbs (11,339.8 grams) of the setting-type joint compound according to this disclosure.

The setting-type joint compound can be used in any application in which a joint compound can be used. In particular, the setting-type joint compound is useful as a finishing (top) joint compound coating when constructing an interior wall from a wallboard assembly and as a patching compound for repairing imperfections including indentations, nail and screw holes, on the wallboard surface. The setting-type joint compound can be further used in any other applications for finishing walls and ceilings, including for making a textured surface.

It has been unexpectedly found that the setting-type joint compound according to this disclosure has an enhanced bond to non-porous surface, and in particular a wallboard facer paper having a porosity lower than that of a manila facer paper.

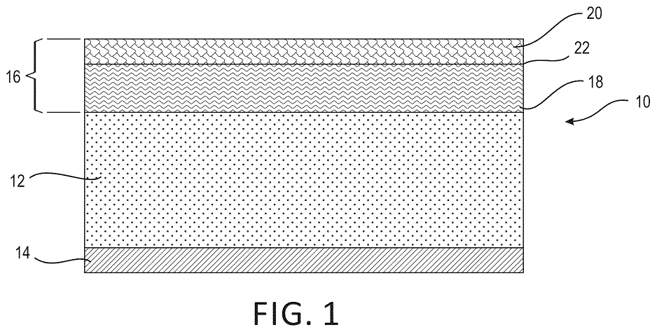

Referring to FIG. 1, it depicts a cross-sectional view of one embodiment for a wallboard which can be also referred to as drywall, plaster board or gypsum board, generally (10), to which the setting-type joint compound according to this disclosure can be applied.

The wallboard (10) comprises a gypsum core (12) extruded between a backer paper sheet (14) and a facer paper sheet (16). The wallboard (10) is typically rectangular in shape, having two long surfaces, one of which is covered with the backer paper sheet (14) and the other one is covered with the facer paper sheet (16), respectively.

The facer paper sheet (16) comprises several plies of paper fibers (18) pressed together and coated over with a surface coating (20) applied over the outer surface (22) of the facer paper sheet (16). After the wallboard (10) is installed as a wall, the surface coating (20) is an exterior layer facing the room. The surface coating (20) is a polymeric coating which may comprise a pigment. Suitable pigments may include clay, titanium dioxide, or calcium carbonate. The polymeric coating (20) may comprise a polyacrylic binder in embodiments.

During installation, the wallboard (10) may be attached to a frame (not shown) with the facer paper sheet (16) facing toward a room. Seams (joints) between adjacent wallboards (10s) are filled with a joint compound and embedded with joint tape. The setting-type joint compound according to this disclosure may be then applied over the seam (joint) and over a portion of the adjacent wallboard facer paper sheet (16). Preferably, the facer paper sheet (16) does not comprise flyleaf fibers obtained by recycling paper comprising lightly printed trims from magazines, catalogs, and similar printed materials. Preferably, the surface coating (20) is a polymeric coating comprising a pigment. In embodiments, the polymeric coating may be an acrylic coating and/or the pigment may comprise clay, calcium carbonate and/or titanium dioxide.

In this disclosure, a joint seam may be referred interchangeably as “joint,” and it refers to a seam between two abating wallboards (10s) being attached to a frame, including flat seams between wallboards which are attached in the same plane, as well as corner seams between two wallboard panels which are attached at an angle.

The porosity of the facer paper (16) may be significantly lower than a porosity of manila paper which can be made with unbleached wood pulp and typically comprises two plies comprising flyleaf fibers, or similar ground wood paper grades. In this disclosure, a porosity can be measured in seconds using the Gurley porosimeter which measures the time in seconds, it takes for 100 cm³ of air to pass through the area of one square inch of the facer paper sheet (16) when the facer paper sheet (16) is tested with the surface coating (20) being the first surface that the air sample is traversing. Measurements are taken at room temperature and normal atmospheric pressure.

While a manila facer paper may have a porosity ranging from 35 to 150 seconds per 100 cm³, preferably 40-60 seconds per 100 cm³, the facer paper sheet (16) may have a porosity of 150 seconds per 100 cm³, 300 seconds per 100 cm³, or even 500 seconds per 100 cm³ or higher. All porosity measurements are taken with the Gurley porosimeter, as described above. Thus, the facer paper sheet (16) is significantly less porous than a manila paper sheet.

In this disclosure, the non-porous surface or the low porosity paper sheet is defined as a paper sheet that has a porosity of 150 seconds per 100 cm³ or more, 300 seconds per 100 cm³ or more, or ranging from 100 to 500 seconds/100 cm³, as measured with the Gurley porosimeter at room temperature and normal atmospheric pressure.

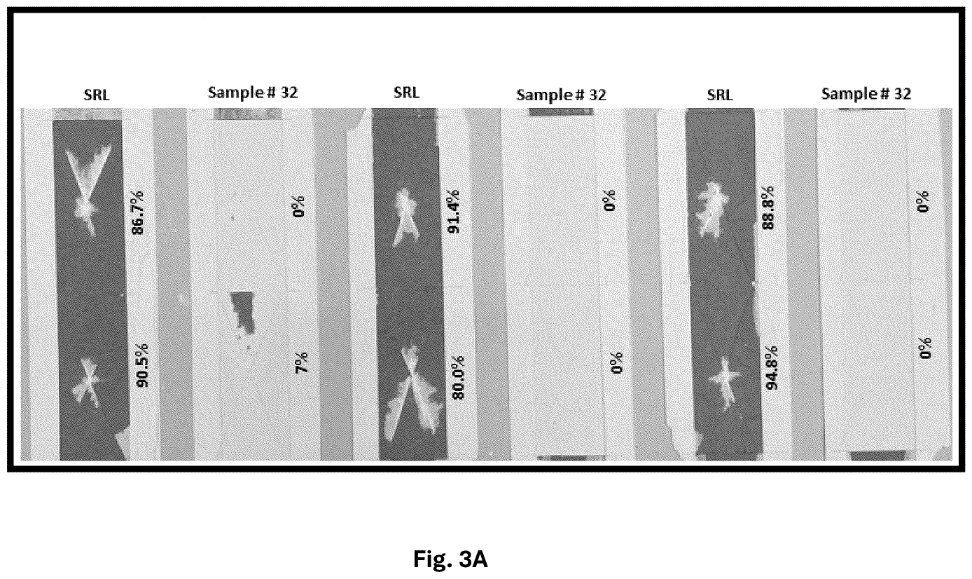

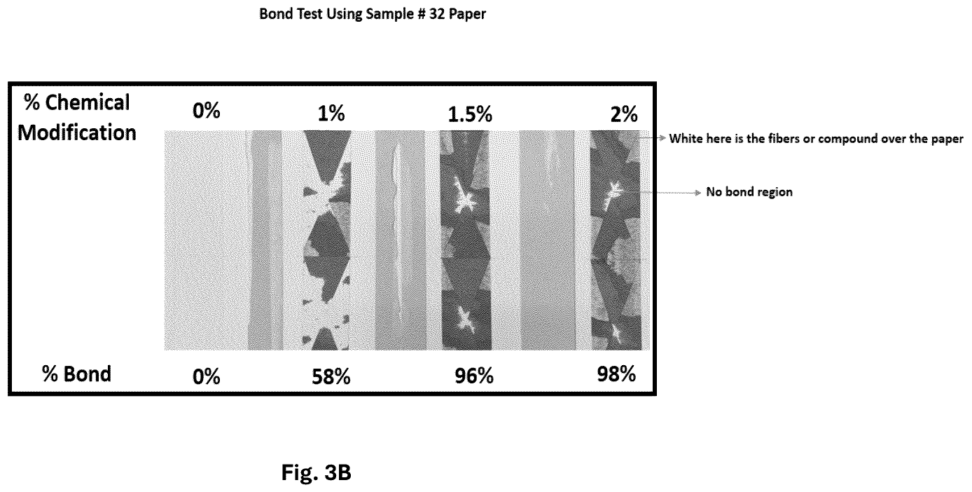

By a comparative analysis, it was unexpectedly found that the setting-type joint compound according to this disclosure has a much stronger bond to the wallboard facer paper sheet (16) than a conventional joint compound, as shown in FIGS. 3A and 3B.

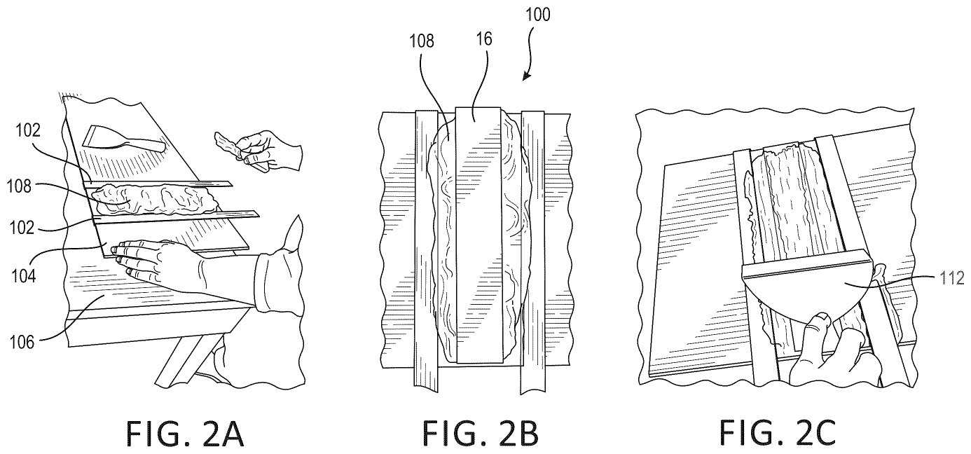

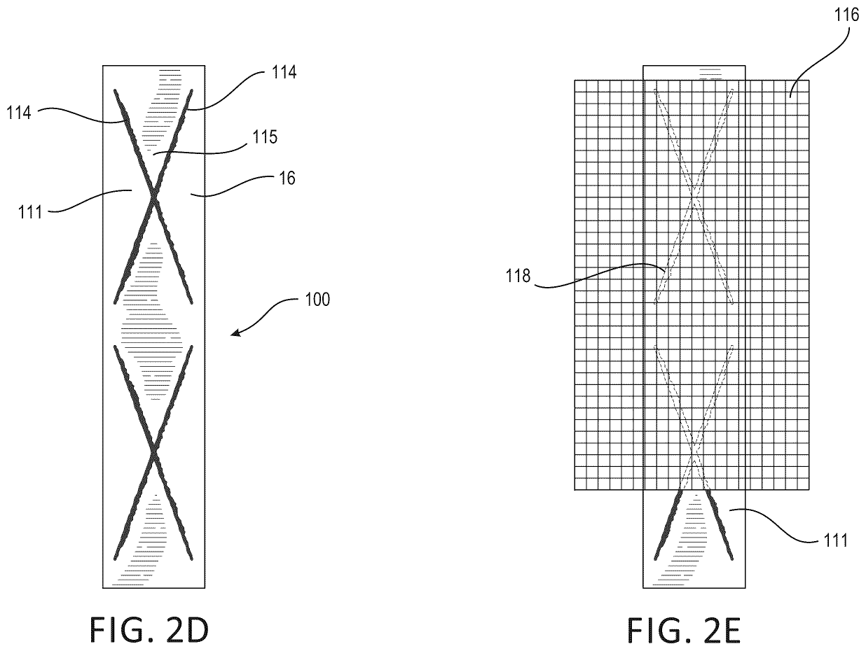

In order to evaluate bonding of a setting-type joint compound according to this disclosure to wallboard facer paper sheet (16), the following paper bonding test was conducted by following provisions of ASTM C 474. Preparation of a test assembly (100) for this test is shown in FIGS. 2A-2E. Two feeler gauge strips (102s), each 12 in. [300 mm] long, ½ in. [14 mm] wide, 0.025 in. [0.64 mm] thick are applied parallel to each other and 4 inches apart from each other on gypsum wallboard surface (104) positioned horizontally on a flat surface (106), as shown in FIG. 2A.

The setting-type joint compound according to this disclosure (108) is spread to fill a space between the feeler gauge strips (102s) until the thickness of the spread joint compound is achieved in the range of about 0.025 inches [0.64 mm], as shown in FIG. 2A.

Then the facer paper sheet (16) or control manila paper which was cut into strips of 12 inches long and 2 inches wide is placed over the spread joint compound (108) face side down, as shown in FIG. 2B, such that surface coated with the coating (20) comes in contact with the setting-type joint compound (108). A steel-reinforced broad knife (112) is used to press the facer paper (110) into the joint compound (108), so that the facer paper (110) makes full contact, as shown in FIG. 2C.

The gauge strips (102s) are removed (not shown), and the test assembly (100) is dried to constant weight in an atmosphere 75±5 °F (24±2 °C) and 50±5% relative humidity, which can be referred to in this disclosure as the 75/50 conditioning.

When the test assembly (100) has dried to constant weight, a sharp knife is used to make a cut (about 3.5 inch long) across and perpendicular to the bonded facer paper (16) surface (111), producing “X” marks (114s) with tabs (115s) on the bonded facer paper surface (111). The tabs (115s) are peeled back with the tip of the knife. The tabs (115s) are then pulled up sharply, separating and removing a portion of the facer paper (16) from the joint compound (108). A transparent photocopy graph paper of 10 by 10 divisions per one inch, hereafter a transparent grid (116) is then placed over the facer paper surface (111) and an area of 2 by 5 inches [50 by 125 mm] enclosing 1000 square divisions is outlined, as shown in FIG. 2E, noting some of the squares (118s) no longer have facer paper (16).

Using the overlaid transparent grid (116), the number of squares (118s) that are more than half bare of the paper are counted. This number is then subtracted from 100 and divided by 10 to determine the percent bond. Two tests are performed for each assembly to be tested.

The results of these paper bond tests are reported in FIG. 3A and FIG. 3B. In FIG. 3A, a conventional joint compound is used which did not comprise the vinyl acetate co-polymer binder according to this disclosure. While paper bonding is satisfactory to conventional manila facer paper as shown in SRLs panels, the bonding is unsatisfactory (7% or less) with the low-porosity facer paper sheet (16) (Samples #32).

In FIG. 3B, the joint compound according to this disclosure is used for bonding to the low-porosity paper sheet (16). As reported in FIG. 3B, the bonding is improved from 0% to 96% and higher for the setting-type joint compound in a binder concentration dependent manner, with acceptable bonding of 90% or higher being achieved at 1.5 wt % or higher concentration of the binder comprising a vinyl acetate co-polymer, preferably vinyl acetate-ethylene co-polymer.

In another aspect, this disclosure relates to a method for finishing wallboard seams and wallboard during installation, and for wallboard repair. In these methods, the setting-type joint compound is mixed with water into a paste and the paste may be applied over the wallboard surface needing to be repaired or finished. The applied setting-type joint compound paste is allowed to harden and may be sanded. The wallboard surface may be finished by applying a paint coat or some other decorative coating. The setting-type joint compound according to this disclosure is also suitable for finishing flat and corner seams. In these applications, the setting-type joint compound may be applied over embedded tape as a second and/or third coating and over a corner bead.

In yet another aspect, this disclosure relates to methods for preparing the setting-type joint compound according to this disclosure. In these embodiments, all components may be mixed into a powder form. A user can add water prior to use.

The following non-limiting examples are provided with this disclosure.

### Example 1

The setting-type joint compounds according to this disclosure were formulated a binder that comprises a vinyl acetate co-polymer (RDP) by mixing the components listed in Table 2. A control setting-type joint compound (0 wt % RDP) was prepared without the vinyl acetate co-polymer.

TABLE 2

| | 0% RDP | | | |
|---|---|---|---|---|
| | (Control) | 1% RDP | 1.5% RDP | 2% RDP |
| Calcined | 47.37% | 46.90% | 46.66% | 46.42% |
| Gypsum | | | | |
| Calcium | 42.11% | 41.69% | 41.48% | 41.26% |
| Carbonate | | | | |
| Attapulgite | 3.51% | 3.47% | 3.46% | 3.44% |
| Clay | | | | |
| Silicone- | 5.26% | 5.21% | 5.18% | 5.16% |
| Coated | | | | |
| Expanded | | | | |
| Perlite | | | | |
| Cellulosic | 0.35% | 0.35% | 0.35% | 0.34% |
| Thickener | | | | |
| Corn Starch | 0.17% | 0.17% | 0.17% | 0.17% |
| Pregelatinized | 0.88% | 0.87% | 0.86% | 0.86% |
| Wheat Starch | | | | |
| Polyvinyl | 0.11% | 0.10% | 0.10% | 0.10% |
| Alcohol | | | | |
| Sugar-Coated | 0.04% | 0.03% | 0.03% | 0.03% |
| Gypsum | | | | |
| Keratin- | 0.07% | 0.07% | 0.07% | 0.07% |
| Based | | | | |
| Preparation | | | | |
| (Setting- | | | | |
| Reaction | | | | |
| Controlling | | | | |
| Agent) | | | | |
| Magnesium | 0.14% | 0.14% | 0.14% | 0.14% |
| Hydroxide | | | | |
| Vinyl-Acetate | 0.00% | 1.00% | 1.50% | 2.00% |
| Binder (RDP) | | | | |
| | 100.00% | | 98.50% | 98.00% |

Setting-type joint compounds were mixed with water in a paste and were tested for bonding to conventional manila paper (SRL samples) or to the wallboard facer paper (16) (samples #32). Results of these tests are reported in FIGS. 3A and 3B. Using the vinyl-acetate-ethylene co-polymer (RDP) improved bonding to non-porous paper (sample #32) in concentration-dependent matter.

### Example 2

Setting-type joint compound compositions were formulated with the following lightweight fillers according to this disclosure as shown in Table 3 below. These formulations enhance the hand mixing ease while mixing with water. The hand mixing ease was enhanced when SilCell™ 35 BC perlite was replaced with hollow microspheres like 3M™ Glass Bubbles, K1 Glass bubbles, or Dualite™ polymeric hollow microspheres filled with gas and surface-coated with calcium carbonate.

TABLE 3

| | SilCell ™ | 3M ™ Glass | | Dualite ™ |
|---|---|---|---|---|
| | 35BC | Bubbles (iM16K) | K1 | E055 |
| Calcined | 47.70% | 47.83% | 48.67% | 49.38% |
| Gypsum | | | | |
| Calcium | 42.71% | 42.83% | 43.58% | 44.21% |
| Carbonate | | | | |
| Silicone- | 4.42% | | | |
| Coated | | | | |
| Expanded | | | | |
| Perlite | | | | |
| 3M ™ Glass | | 4.43% | | |
| Bubbles | | | | |
| (iM16K) | | | | |
| 3M ™ Glass | | | 2.48% | |
| Bubbles K1 | | | | |
| Dualite ™ | | | | 1.05% |
| E055 | | | | |
| expanded | | | | |
| polymeric | | | | |
| hollow | | | | |
| microspheres | | | | |
| filled with | | | | |
| gas and | | | | |
| surface- | | | | |
| coated with | | | | |
| calcium | | | | |
| carbonate | | | | |
| Attapulgite | 3.68% | 3.69% | 3.76% | 3.81% |
| Clay | | | | |
| Cellulosic | 0.29% | 0.23% | 0.29% | 0.30% |
| Thickener | | | | |
| Pregelatinized | 0.92% | 0.69% | 0.94% | 0.95% |
| Wheat Starch | | | | |
| Polyvinyl | 0.20% | 0.22% | 0.20% | 0.21% |
| Alcohol | | | | |
| Magnesium | 0.018% | 0.018% | 0.019% | 0.019% |
| Oxide | | | | |
| Sugar-Coated | 0.022% | 0.022% | 0.023% | 0.023% |
| Gypsum | | | | |
| Keratin- | 0.045% | 0.045% | 0.046% | 0.047% |
| Based Blend | | | | |
| | 99.95% | 99.95% | 99.95% | 99.95% |

We claim:

1. A setting-type joint compound composition in powder comprising:
calcium sulfate hemihydrate;
calcium carbonate;
a lightweight filler comprising silicone-coated expanded perlite microspheres, hollow glass microspheres, and/or expanded polymeric hollow microspheres filled with gas and surface-coated with calcium carbonate;
a binder comprising a vinyl acetate co-polymer;
a thickener comprising clay, starch, a cellulosic thickener, or any combination thereof;
a dispersant;
magnesium oxide or magnesium hydroxide; and
a set initiator comprising ground gypsum,
wherein the setting-type joint compound composition is suitable for use over a wallboard coated paper facer.

2. The setting-type joint compound composition of claim 1, wherein the setting type composition consists essentially of:
40-60 wt % calcium sulfate hemihydrate;
35-50 wt % calcium carbonate;
1-9 wt % of the lightweight filler;
1.5-5 wt % of the binder;
0.1-1 wt % of the cellulosic thickener;
1.0-10 wt % of attapulgite clay;
0.5-5 wt % of starch;
0.01-1.2 wt % magnesium oxide or magnesium hydroxide;
0.02-1.0 wt % dispersant;
0.01-0.1 wt % of the set initiator; and
0.00-0.1 wt % of keratin-based setting-reaction controlling agent.

3. The setting-type joint compound composition of claim 1, wherein the binder comprises a vinyl acetate-ethylene co-polymer.

4. The setting-type joint compound composition of claim 1, wherein the binder further comprises polyvinyl alcohol.

5. The setting-type joint compound composition of claim 1, wherein the composition comprises pregelatinized corn and/or wheat starch.

6. The setting-type joint compound composition of claim 1, wherein the setting-type joint compound composition has at least 80% bond to wallboard facer paper having a porosity ranging 35-500 seconds/100 cm³.

7. The setting-type joint compound composition of claim 6, wherein the setting-type joint compound composition has at least 90% bond to wallboard facer paper having the porosity ranging 150-500 seconds/100 cm³.

8. The setting-type joint compound composition of claim 1, wherein the set initiator comprises ground gypsum coated with sugar.

9. The setting-type joint compound composition of claim 1, wherein the binder comprises a mixture of vinyl acetate-versatic ester co-polymer, ethylene vinyl acetate and vinyl alcohol co-polymer, vinyl alcohol polymer and vinyl acetate polymer.

10. The setting-type joint compound composition of claim 1, wherein the wallboard coated paper facer comprises a surface polymeric coating comprising a pigment.

11. A method of finishing or repairing wallboard having a facer paper sheet, the method comprising mixing the setting-type joint compound composition of claim 1 with water into a paste and applying the paste over at least a portion of the facer paper sheet surface.

12. The method of claim 11, wherein the method further comprises sanding after the applied paste has hardened.

13. The method of claim 11, wherein the facer paper sheet does not comprise flyleaf fibers.

14. The method of claim 11, wherein the facer paper sheet has a porosity ranging from 100 to 500 seconds per 100 cm³.

15. The method of claim 14, wherein the porosity is measured according to the ASTM C 474 paper bonding test.
